(19) United States
(12) Patent Application Publication
(10) Pub. No.: US 2003/0140628 A1
(43) Pub. Date: Jul. 31, 2003

(54) By-pass incorporated in hydraulic control and activation cylinders to facilitate air bleeding

(76) Inventor: Giorgio Gai, Casella (IT)

Correspondence Address: Richard M. Goldberg, Suite 419, 25 East Salem Street, Hackensack, NJ, 07601, US

(21) Appl. No.: 10/341,897

(22) Filed: Jan. 14, 2003

(30) Foreign Application Priority Data
Jan. 25, 2002 (IT) GE2002A000007

(51) Int. Cl. F15B 7/10

(52) U.S. Cl. 60/584

(57) ABSTRACT

A hydraulic control arrangement including a hydraulic driving pump including a tank and vent; a cylinder to facilitate air bleeding and purging in a hydraulic circuit, the cylinder including a jacket, cylinder heads at opposite ends of the jacket, a piston movable in the jacket, drive rods connected with opposite sides of the piston and protruding from the cylinder heads, cylinder chambers in the jacket on opposite sides of the piston, a by-pass in the jacket which connects the cylinder chambers, and a valve associated with the by-pass; fluid coupling fittings at opposite ends of the jacket; pipes connected with the fittings to independently connect the cylinder chambers to the hydraulic driving pump; and a valve arrangement fluidly connected between the pipes and the hydraulic driving pump to speed up and simplify hydraulic fluid feed and air purging operations of the cylinder chambers.

### BACKGROUND OF THE INVENTION

The present invention covers pump driven hydraulic cylinders used for moving mechanical components, and in particular, to control boat rudders or motors.

It is well known that hydraulic cylinders must be filled with fluid and this requires careful air bleeding.

Furthermore, in the case of hydraulic cylinder control of twin motors or twin rudders, it is necessary to balance and maintain parallelism between these motors or rudders, to prevent power loss. In known systems, the air is bled through special bleeder valves located on the pipe fittings connecting the cylinder chambers to the fluid delivery and circulation pump. These bleeder valves are therefore located outside the cylinders.

In the present invention, special but not exclusive attention is paid to cylinders used to move and control the motors or rudders of boats, while it must be stressed that the present invention is also valid for any other kind of hydraulic cylinders and for any other function.

At present, air bleeding is achieved, as mentioned above, by bleeder valves which provide sequential circulation cycles for bleeding the air to the outside of the cylinder, while the chambers and pipes are being filled with hydraulic fluid. As already explained, these valves are derived from branch pipes connecting the cylinder chambers to the pump. Purging is achieved as follows.

In the first phase, the bleeder valves are closed when filling is started.

During the second filling stage, for example, the left-side bleeder valve is opened and the hand wheel is rotated clockwise so that the piston moves to the left and the air in, the left cylinder chamber is bled through the valve.

During the next phase, turning the hand-wheel counterclockwise, the left-side pipe is bled until the liquid freely flows-through the valve and is collected in a special vessel.

In the next phase, the left-side bleeder valve is closed while the right-side bleeder valve is opened, so that, turning the handwheel counterclockwise, the piston moves to the right side to the end of its stroke and the air is bled from the right side cylinder chamber.

Finally, to vent the air from the right side pipe, the hand wheel is turned clockwise and the fluid bled through the right side valve is collected in a special vessel.

Both bleeder valves are the closed for normal operation of the cylinder.

These operations must be repeated several times to completely vent the air from the cylinder chambers and pipes and thus ensure perfect cylinder-operation. This purging with bleeder valves located outside the cylinder is therefore rather complex time consuming and also requires a collecting vessel for the fluid drained through the valves.

### SUMMARY OF THE INVENTION

The present invention has the aim to speed up and facilitate air bleeding by means of a by-pass incorporated in the cylinder and connecting the two chambers.

This by-pass is fitted with opening and closing devices. When open, the air and fluid mixed with air will freely flow from one cylinder chamber to the other, through the pipes connecting the cylinder chambers to the pump, then to be discharged through the bleeder valve which will then convey the fluid returning from the cylinder to the interior of the pump tank, thus preventing the circulation of fluid mixed with air. These valves may be built into the pump and are fitted on branch pipes connecting the pump to the cylinder and to the pump tank.

Air bleeding is achieved in the following steps.

At the initial filling stage, the by-pass of the hydraulic cylinder and the valve discharging into the pump tank are closed.

The by-pass of the cylinder and one discharge valve, for example, the right side valve, is opened so that the fluid returning from the right side cylinder chamber will be discharged into the pump tank.

The hand wheel is turned counterclockwise and the piston in the hydraulic cylinder moves to the right so that the air in the right side cylinder chamber and pipe is discharged in the pump tank. The handwheel is rotated five or six turns in the same sense to bleed the air from the delivery line.

The right-side discharge valve is then closed and the left side valve is opened.

When turning the hand wheel clockwise, the cylinder piston with its open by-pass will move to the left and the air in the left-side cylinder chamber and pipe will be discharged into the pump tank. In this case too, the handwheel should be rotated repeatedly in the same sense to completely purge the line.

The system is now completely vented and the by-pass on the cylinder as well as both discharge valves are closed for normal operation so that the connection between the cylinder chambers and the pump tank is interrupted. The by-pass incorporated in the hydraulic cylinder may be used for twin motors or twin-rudders to ensure a balanced position of the two motors or of the two rudders, even when the system is already filled with fluid. In fact, by successively opening the by-pass of both cylinders and turning the handwheel in a suitable way, it will be possible to achieve a balanced position of the two motors or rudders, as will be explained hereinafter.

Parallelism of the motors or rudders may be achieved with or without a tie rod, but in the latter case, parallelism should be controlled rather frequently.

In known systems, motor and rudder parallelism is achieved with a by-pass on external cylinder pipes.

In a second solution according to this invention, the bleeder valves of the cylinder are replaced by a rotating switch by which the vents on the pump tank and on the pipes connecting the pump to the two hydraulic cylinder chambers are automatically opened and closed.

### BRIEF DESCRIPTION OF THE DRAWINGS

The present invention is described in its exemplified implementation in the attached drawings, in which:

FIGS. 1a-1e show various operation steps of a known air bleeding system of a hydraulic cylinder and its relevant ducts.

FIG. 2 shows a longitudinal section view of a hydraulic cylinder at by-pass level, according to the present invention, in a closed position.

FIG. 3 shows the longitudinal section view of FIG. 2 with its by-pass in an open position.

FIG. 4 shows a longitudinal front view of a hydraulic cylinder, with a connection to the hydraulic pump and the relevant orientation control devices of the motor or rudder.

FIG. 5 shows a side view of the hydraulic cylinder in FIG. 4.

FIGS. 6a-6d, show the various operation steps of the air bleeding system based upon a first solution according to the present invention.

FIG. 7 shows a pump fitted with internal bleeder valves during its normal operation.

FIG. 8 shows the pump illustrated in FIG. 7 during bleeding of the right-side cylinder chamber.

FIGS. 9a-9c show the various operation steps of the bleeder system based on a second solution of the present invention.

FIG. 10 shows the side view and partial section of the purging system, according to the present invention, of coupled cylinders for the motorization of twin motors or twin rudders together with the relevant tie bar.

FIGS. 11a-11d show the equilibration technique of two convergent motors or rudders.

FIGS. 12a-12d show the equilibration technique of two divergent motors or rudders.

### DETAILED DESCRIPTION

With reference to these drawings, particular reference is made to a mechanical control system for a user of any type whatsoever, by means of a hydraulic cylinder driven by a hydraulic pump, and specifically, to the orientation system of motors and rudders of boats.

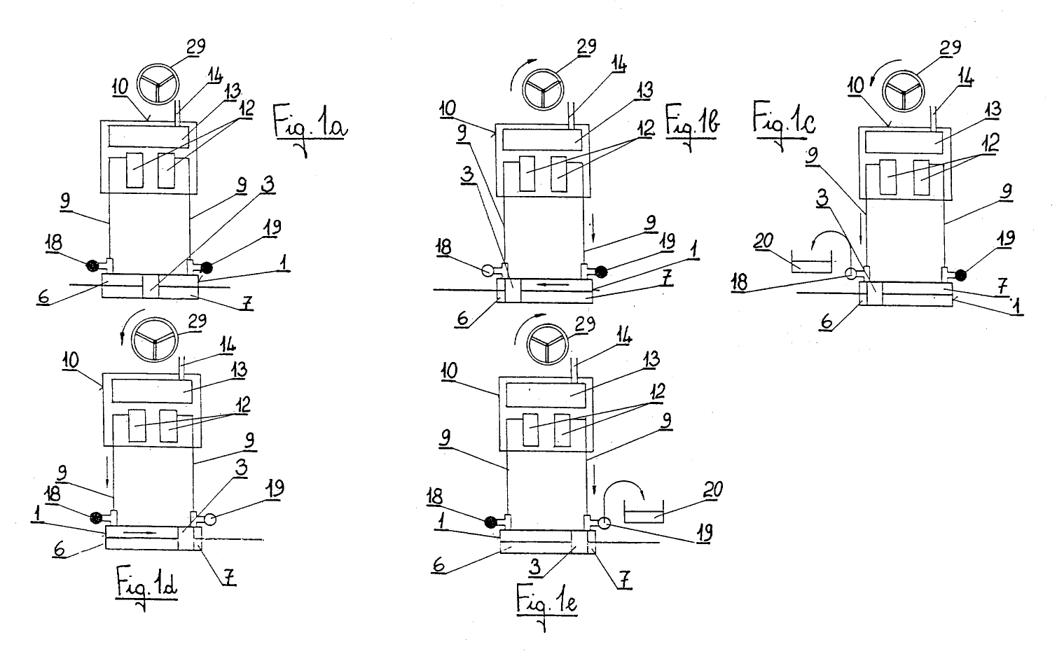

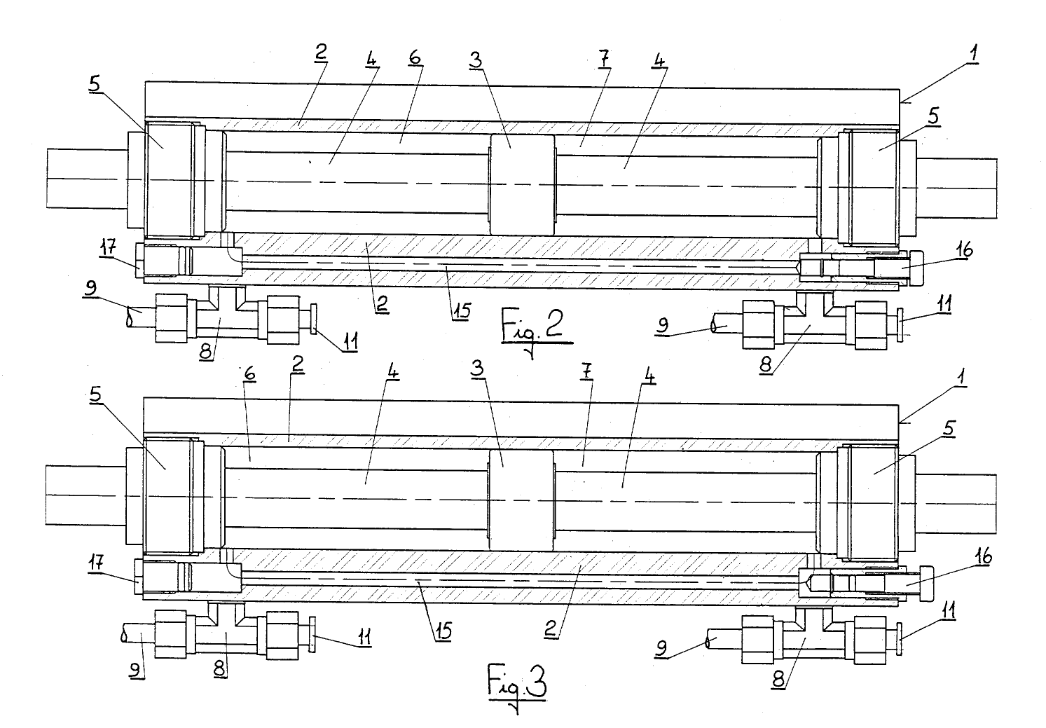

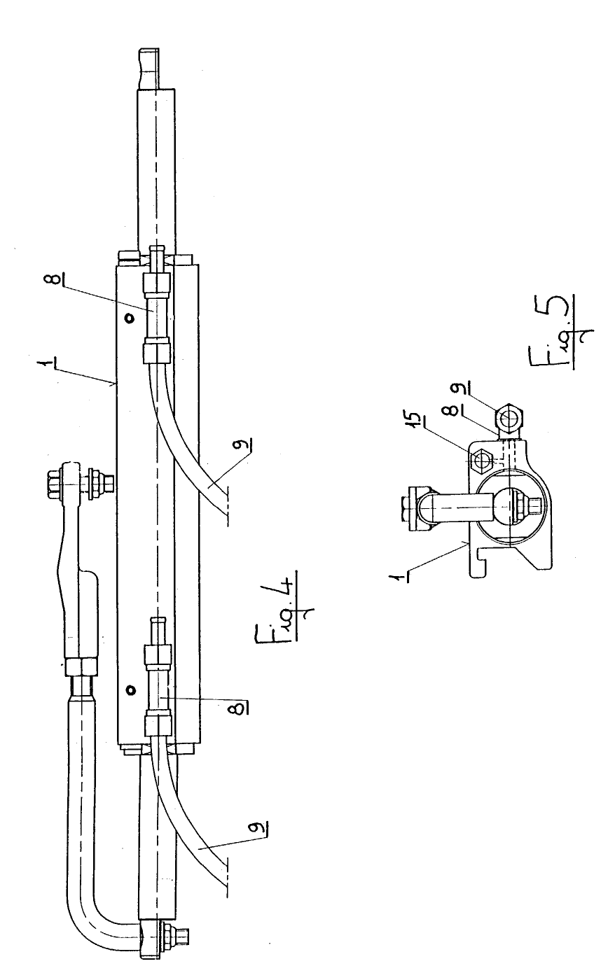

In a known version of such a control system, as shown in FIGS. 1a-1e, and referring also to FIGS. 2 and 3 which incorporate the present invention therein, an operating cylinder 1 includes a proper cylinder jacket 2 in which a piston 3 moves, the piston 3 being provided on both sides with left and right rods 4 protruding from the cylinder head 5 for mechanical connection to the user. This known double-acting cylinder 1 therefore includes a left-side cylinder chamber 6 and a right-side cylinder chamber 7.

These two chambers 6 and 7 are connected by fittings 8 and pipes 9 to a hydraulic pump 10. Preferably, fittings 8 are T-shaped, as shown in the drawings, but are not limited thereby. One branch of each fitting 8 opposite the pump connection is closed by a proper plug 11.

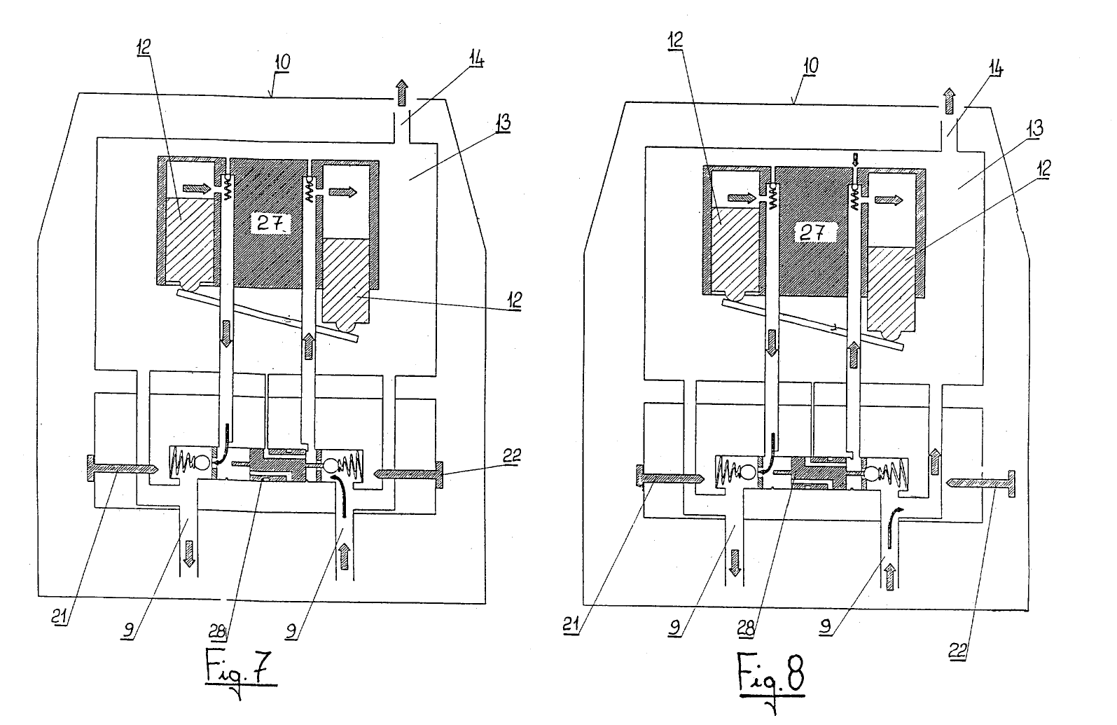

Various versions of hydraulic pump 10 are known, and especially the version shown in FIGS. 7 and 8. Specifically, hydraulic pump 10 is provided with several small pistons 12 connected to a rotor 27. By axial movement, pistons 12 move in their own jackets. Through movement of pistons 12 and by means of a proper piston body 28, and related sphere valves, pistons 12 will convey the fluid, for example, to chamber 6 of a cylinder and drain the fluid from the other chamber, for example chamber 7 and vice versa, thus driving piston 3 of hydraulic cylinder 1. Hydraulic pump 10, as briefly described above, also includes a hydraulic fluid tank 13 provided with a vent 14, and tank 13 is used to fill the chambers associated with pistons 12.

According to the present invention, cylinder 1 includes a by-pass 15, preferably created in a lateral bulge of cylinder jacket 2, fluidly connecting the two cylinder chambers 6 and 7. By-pass 15 is provided with a closing and opening device and features at one end, as exemplified in the drawings, an externally operated opening and closing valve 16, and at the other end, a permanently closed plug 17. As shown in FIGS. 2 and 3, by-pass 15 has its axis in the same plane as T-fittings 8 but may also be off-center, as illustrated in FIG. 5.

FIGS. 1a-1e, regarding a hydraulic cylinder for orientation of motors or rudders of boats, show the hook-up of a known air bleeder system. With reference to this known bleeder system, left side and right side bleeder valves 18 and 19 are fitted on the outside of hydraulic cylinder 1 and are connected to pipes 9 connecting chambers 6 and 7 of hydraulic cylinder 1 to pump 10.

As shown for exemplification in FIG. 1a, filling is started with closed bleeder valves 18 and 19.

In the second step, illustrated in FIG. 1b, left side bleeder valve 18 is opened whereby piston 3 is moved to the left by the pressure of the fluid in right-side pipe 9 feeding chamber 7 of cylinder 1. By turning a handwheel 29 connected with piston 3 and rods 4 clockwise, piston 3 is moved to the left up to its end stroke, and the air captured in left chamber 6 escapes through bleeder valve 18.

In the third step, by rotating handwheel 29 counterclockwise, the air escapes from left-side pipe 9 until the fluid freely flows through bleeder valve 18 and is collected in a special vessel 20, as shown in FIG. 1c.

In the fourth step shown in FIG. 1d, left-side bleeder valve 18 is closed while right-side bleeder valve 19 is opened, and by turning handwheel 29 counterclockwise, piston 3 is shifted to the right up to the end of its stroke and the air captured in right side chamber 7 of cylinder 1 escapes through right-side-bleeder valve 19.

In the fifth step shown in FIG. 1e, handwheel 29 is turned clockwise to bleed the air from right-side pipe 9 until the fluid freely flows through bleeder valve 19 and is collected in a special vessel 20.

Obviously, this known air bleeding system is rather complex and the steps must be repeated to eliminate all air from the system and to ensure faultless operation of the cylinder and perfect orientation of the rudder or motor.

The present invention has the aim to speed up air bleeding without requiring a vessel in which to collect the hydraulic fluid discharged through the valves.

As explained above, this new bleeding system is obtained by a by-pass located between chambers 6 and 7 of cylinder 1, and this by-pass is incorporated in the hydraulic cylinder.

According to a first embodiment of the present invention, the air is bled through built-in discharge valves 21 and 22 (FIGS. 7 and 8) respectively on the left and right side of the pump and mounted on branch pipes 9 of the feed and discharge of cylinder chambers 6 and 7 of cylinder 1, while valves 21 and 22 and their branch pipes discharge into vessel 13 of pump 10 which is fitted with vent 14.

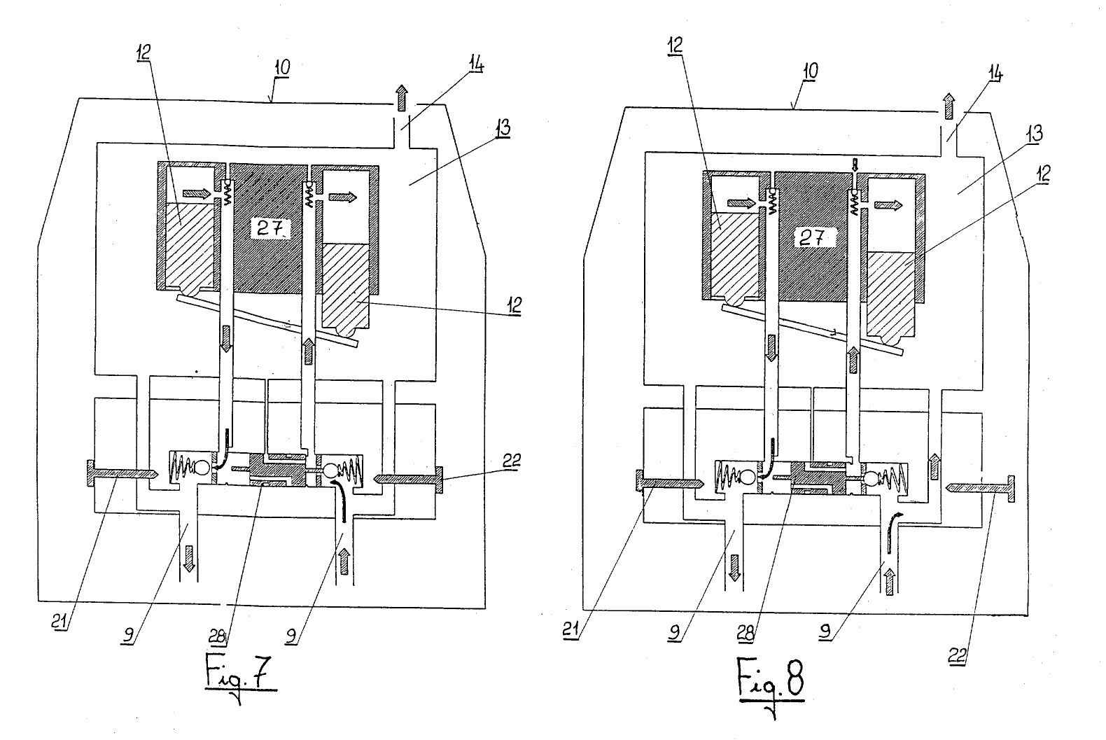

Therefore, this simplified bleeder sequence is achieved in four steps, as illustrated in the FIGS. 6a-6d.

In the first filling step of the system shown in FIG. 6a, bleeder valves 21 and 22 on the left and right side are closed and valve 16 of by-pass 15 is also closed.

In the second step shown in FIG. 6b, valve 16 of by-pass 15 as well as right-side discharge valve 22 are opened. By turning handwheel 29 counterclockwise, piston 3 moves to the right up to the end of its stroke, and the air or fluid mixed with air in cylinder chamber 7 and in right-side pipe 9 are discharged into vessel 13 of pump 10.

In the third step shown in FIG. 6c, valve 16 of by-pass 15 of hydraulic cylinder 1 still remains open, right-side discharge valve 22 is closed and left-side discharge valve 21 is opened. By rotating handwheel 29 clockwise, piston 3 moves to the left up to the end of its stroke and the air or fluid mixed with air in left side chamber 6 of cylinder 1 and in left-side pipe 9 are discharged into vessel 13 of pump 10.

The system is now airless and valve 16 of by-pass 15 as well as both discharge valves 21 and 22 are closed for normal operation, as illustrated in the fourth step of FIG. 6d.

FIGS. 7 and 8 schematically show a pump used to control a hydraulic cylinder and illustrating the internal arrangement of the branch pipes on which discharge valves 21 and 22 are mounted. FIG. 7 shows in detail the pump during normal operation of the cylinder with closed discharge valves 21 and 22, whereas FIG. 8 shows air bleeding of right-side chamber 7 with closed left-side discharge valve 21 and open discharge valve 22. Operations are similar for air bleeding of cylinder chamber 6.

FIG. 10 shows an application example in the case of twin motors or twin rudders controlled by two hydraulic cylinders 23, 24. The mechanical and fluid couplings between the two cylinders and the hydraulic pump are quite clear and need no further explanation. This new purging system allows for air bleeding of both cylinders and to correct motor or rudder parallelism even after the system has been filled with fluid and purged.

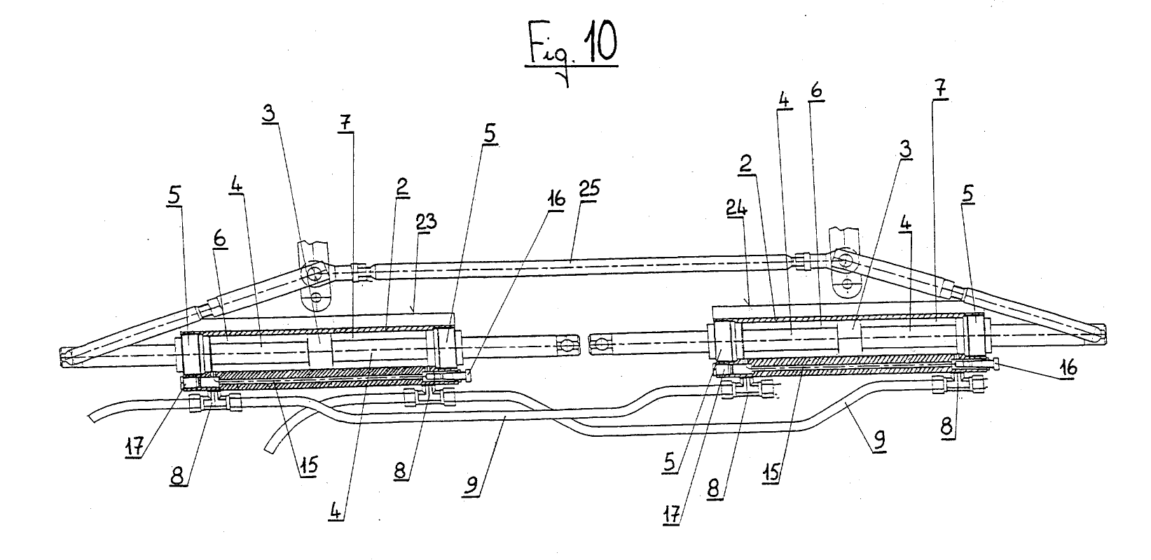

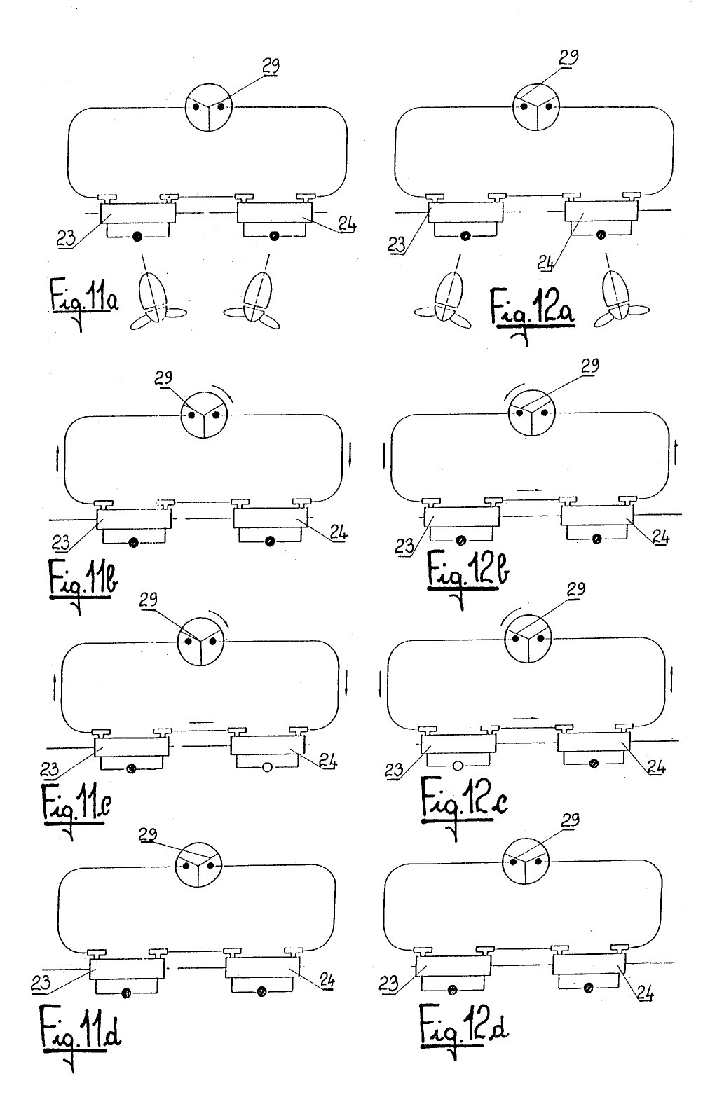

FIGS. 11a-11d show a simplified hydraulic adjustment diagram of converging motors according to this invention, whereas FIGS. 12a-12d show a hydraulic adjustment diagram of divergent motors.

According to this invention with a by-pass incorporated in the cylinders, hydraulic adjustment is achieved as follows.

For convergent motors, alignment is started by complete clockwise rotation of handwheel 29 (cf. the position in FIG. 11b), while both by-passes 15 of the cylinders are closed. When the handwheel is blocked, the by-pass of cylinder 24 is opened (cf. the position in FIG. 11c) and the handwheel may now be turned clockwise until it is blocked. The by-pass 15 of cylinder 24 is now closed (cf. the position in FIG. 11d).

In the case of divergent motors, handwheel 29 is rotated counterclockwise (cf. the position in FIG. 12b) with both by-passes of the cylinders closed, until the handwheel is blocked. The bypass 15 of cylinder 23 is opened (cf. the position in FIG. 12c) and the handwheel is further rotated counterclockwise until it is blocked. The by-pass of cylinder 23 is closed (cf. the position in FIG. 12d).

By these two alignment procedures, the boat will turn about correctly and permit safe maneuvering. Motor or rudder alignment should always be checked before using the boat if the system is without a rigid tie bar.

However, if the system is also equipped with a tie bar 25 (cf. FIG. 10), the above alignment procedure is made at the time of installation (before the rigid tie bar is connected) and needs only be repeated occasionally.

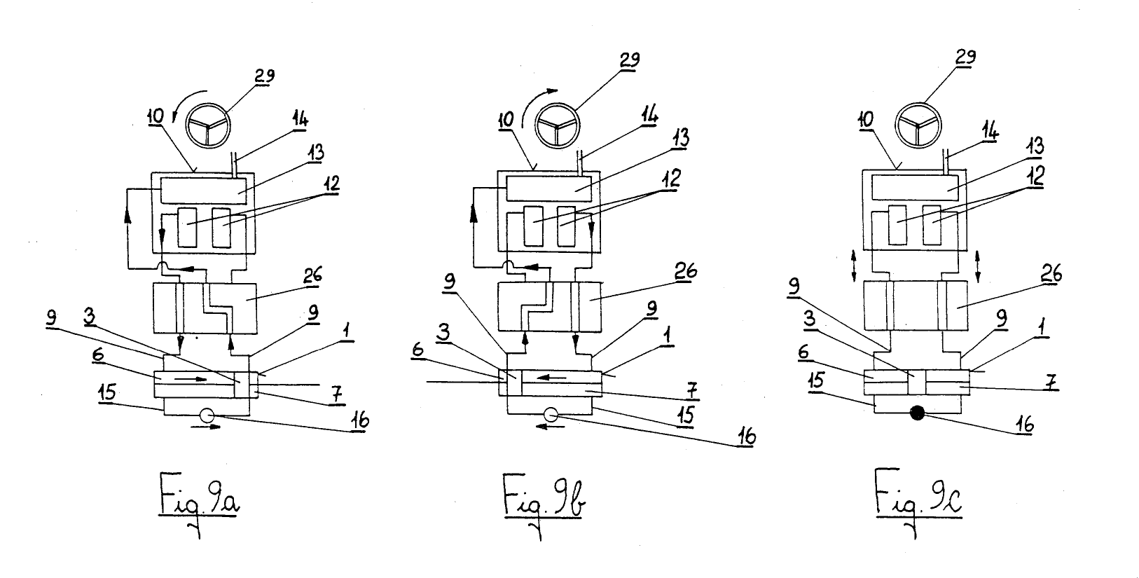

According to another solution based upon this invention, discharge or bleeder valves 21 and 22 are eliminated and replaced by a switching device 26, usually designed for hand operation, internally, provided for example with three pairs of streamlines, as shown in FIGS. 9a-9c.

According to this solution, in the first step illustrated in FIG. 9a, switch 26 is positioned, for example, so that by turning handwheel 29 counterclockwise, the hydraulic fluid delivered by the pump will feed left-side chamber 6 of cylinder 1 while valve 16 of by-pass 15 is open, while right-side chamber 7 discharges into tank 13 of pump 10. This step, according to FIG. 9a, matches the step of the first solution illustrated in FIG. 6b, and permits completely to purge right-side chamber 7 of cylinder 1.

Similarly, according to FIG. 9b, when rotating the handwheel clockwise, the hydraulic fluid delivered by the pump will feed right-side chamber 7 of cylinder 1 while valve 16 of by-pass 15 is open and left-side chamber 6 discharges into tank 13 of pump 10.

This step, according to FIG. 9b, matches the step of the first solution illustrated in FIG. 6c and permits completely to purge left-side chamber 6 of cylinder 1.

FIG. 9c shows the normal operation phase of the hydraulic cylinder system and matches FIG. 6d of the first solution.

Obviously, the above exemplified description and illustration may be subject to variations and adjustments based on the multivarious applications of single or multiple hydraulic cylinder control systems, while keeping in mind that by-pass 15 is never used for filling or discharging of cylinder chambers 6 and 7, and that by-pass 15 is fitted with its own closing valve 16 during normal operation of the cylinder.

What is claimed is:

1. A hydraulic control arrangement comprising:
a hydraulic driving pump including a tank and vent;
at least one operation cylinder to facilitate air bleeding and purging in a hydraulic circuit, each said cylinder including:
an external jacket,
cylinder heads at opposite ends of the jacket,
a piston movable in said jacket,
right and left drive rods connected with opposite sides, respectively, of the piston and protruding from the cylinder heads,
left and right cylinder chambers in said jacket on opposite sides of said piston,
a by-pass in the jacket of the cylinder and which connects the left and right cylinder chambers of the cylinder, and
an externally controlled opening and closing device associated with the by-pass;
fluid coupling fittings at opposite ends of the jacket;
pipes connected with the fluid coupling fittings and which independently connect the left and right cylinder chambers to the hydraulic driving pump; and
a valve arrangement fluidly connected between the pipes and the hydraulic driving pump to speed up and simplify hydraulic fluid feed and air purging operations of the left and right cylinder chambers.

2. A hydraulic control arrangement according to claim 1, wherein the by-pass is provided in a lateral bulge of the jacket.

3. A hydraulic control arrangement according to claim 1, wherein:
the fluid coupling fittings at opposite ends of the jacket include a left fluid coupling fitting at a left side of the jacket and a right fluid coupling fitting at a right side of the jacket;
the pipes connected with the fluid coupling fittings include a left side pipe which connects the left cylinder chamber to the hydraulic driving pump and a right side pipe which connects the right cylinder chamber to the hydraulic driving pump; and
the valve arrangement includes a left bleeder valve fluidly connected between the left side pipe and tank a right bleeder valve fluidly connected between the right side pipe and tank.

4. A hydraulic control arrangement according to claim 3, wherein:
the pump includes a pump casing which includes the tank and the vent; and
the bleeder valves are incorporated in the pump casing.

5. A method for using the hydraulic control arrangement according to claim 3 to purge said left and right cylinder chambers of air, wherein the hydraulic control arrangement further includes a handwheel connected with at least one said drive rod, the method comprising the steps of:
first operation steps of:
closing the left and right bleeder valves, and
closing the externally controlled opening and closing valve associated with the by-pass;
second operation steps of:
opening the externally controlled opening and closing valve associated with the by-pass,
opening the right bleeder valve, and
turning the handwheel in a first direction to move the piston to the right up to the end of its stroke so as to discharge air and any fluid mixed with the air in the right cylinder chamber and in the right side pipe into the tank of the pump;
third operation steps of:
maintaining the externally controlled opening and closing valve-associated with the by-pass open,
closing the right bleeder valve,
opening the left bleeder valve, and
turning the handwheel in a second opposite direction to move the piston to the left up to the end of its stroke so as to discharge air and any fluid mixed with the air in the left cylinder chamber and in the left right side pipe into the tank of the pump, wherein the left and right cylinder chambers are airless; and
fourth operation steps of:
closing the externally controlled opening and closing valve associated with the by-pass open, and
closing the left bleeder valve to provide for normal operation of the hydraulic control arrangement.

6. A hydraulic control arrangement according to claim 1, wherein the valve arrangement includes a switching device internally provided with a plurality of flow line couplings selectively coupled to the pipes to permit purging of the left and right cylinder chambers into the tank.

7. A hydraulic control arrangement according to claim 6, wherein there are three different flow line couplings.

8. A hydraulic control arrangement according to claim 6, wherein the switching device is hand operated.

9. A method for using the hydraulic control arrangement according to claim 6 to purge said left and right cylinder chambers of air, wherein the hydraulic control arrangement further includes a handwheel connected with at least one said drive rod, the method comprising the steps of:
first operation steps of:
opening the externally controlled opening and closing valve associated with the by-pass,
turning the handwheel in a first direction, and
controlling the switching device to connect a first flow line coupling thereof to the pipes to permit pumped hydraulic fluid to enter the left cylinder chamber and to permit the right cylinder chamber to discharge into the tank when the handwheel is turned in the first direction;
second operation steps of:
maintaining the externally controlled opening and closing valve associated with the by-pass open,
turning the handwheel in a second opposite direction, and
controlling the switching device to connect a second flow line coupling thereof to the pipes to permit pumped hydraulic fluid to enter the right cylinder chamber and to permit the left cylinder chamber to discharge into the tank when the handwheel is turned in the second, opposite direction; and
a third operation step of controlling the switching device to connect a third flow line coupling thereof to the pipes to provide a direct connection between the cylinder chambers and the pump.

10. A hydraulic control arrangement-according to claim 1, wherein the externally controlled opening and closing device associated with the by-pass includes a valve mounted at one end of the by-pass; and
further comprising a permanent plug fitted with the other end of the by-pass.

11. A hydraulic control arrangement according to claim 1, wherein there are two said operation cylinders for one of:
twin outboard motors, and
twin rudders.

12. A hydraulic control arrangement according to claim 11, further comprising a tie bar for connecting the one of twin outboard motors and twin rudders.

13. A method for using the hydraulic control arrangement according to claim 11 to purge said left and right cylinder chambers of air, wherein the hydraulic control arrangement further includes a handwheel connected with at least one said drive rod, the method comprising the steps of:
for convergent motors:
closing the by-pass for each cylinder,
turning the handwheel completely in a first direction until the handwheel cannot move further,
opening the by-pass of a first one of said cylinders,
turning the handwheel completely in the first direction to a greater extent until the handwheel cannot move further, and
closing the by-pass of the first one of said cylinders; and for divergent motors:
closing the by-pass for each cylinder,
turning the handwheel completely in a second, opposite direction until the handwheel cannot move further,
opening the by-pass of a second one of said cylinders,
turning the handwheel completely in the second direction to a greater extent until the handwheel cannot move further, and
closing the by-pass of the second one of said cylinders.
